(19) United States
(12) Patent Application Publication
(10) Pub. No.: US 2004/0070109 A1
(43) Pub. Date: Apr. 15, 2004

(54) Method for the production of a fiber-reinforced product based on epoxy resin

(76) Inventors: Andreas Palinsky, Moers (DE); Holger Dey, Rheinberg (DE); Ulrich Stieber-Monida Steiber Heir, Mulheim (DE); Antonietta Tumminello, Duisburg (DE); Peter Veit, Leverkusen (DE); Heinz-Gunter Reichwein, Kamp-Lintfort (DE); Jurgen Schillgalies, Moers (DE)

Correspondence Address: Charles A. Muserlian, Muserlian, Lucas and Mercanti, 600 Third Avenue, New York, NY, 10016, US

(21) Appl. No.: 10/457,877

(22) Filed: Jun. 10, 2003

(30) Foreign Application Priority Data
Jun. 26, 2002 (DE) 102 28 649.3

(51) Int. Cl. B29C 70/42; B29C 71/02

(52) U.S. Cl. 264/236; 264/257; 264/338

(57) ABSTRACT

The invention relates to a method for producing a fiber-reinforced product based on epoxy resin.

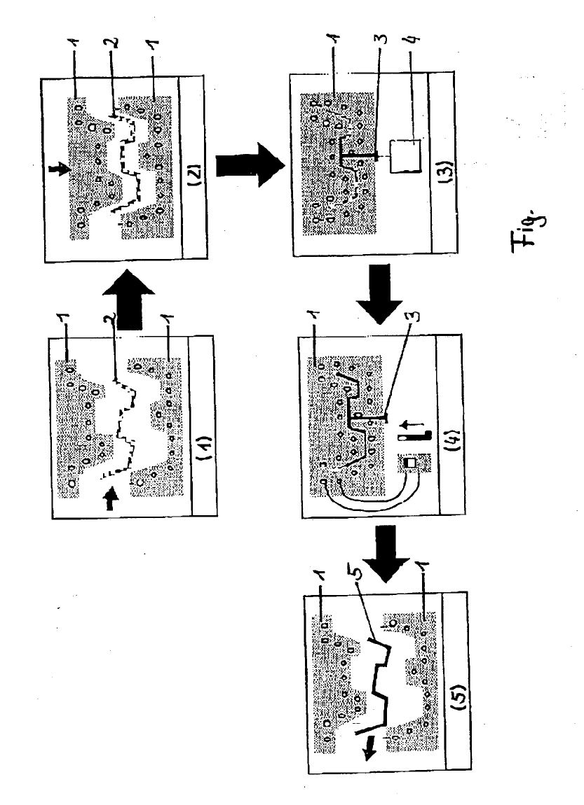

In order to provide a product manufactured in resin transfer molding (RTM), which has excellent impact strength without further mechanical or thermal characteristics being affected, a method is proposed comprising the following steps:

if necessary, preforming of the fibrous material (2),

placing the fibrous material (2) into a mold (1), if necessary, coated with parting means, and closing of the mold (1), wherein the molding of the fibrous material (2) takes place,

injecting a mixture (4) which, relative to 100 pbw of the following components of the mixture, comprises

i) 50 to 70 pbw of an epoxy resin,

ii) 25 to 50 pbw of an aromatic diamine, and

iii) 2 to 25 pbw of cross-linkable elastomer particles based on polyorganosiloxanes with an average particle diameter of 1·10⁻⁸ m to 5·10⁻⁶ m and an average molecular weight of 1,000 to 100,000, with substantially only the surface of the elastomer particles having been modified with reactive groups, which are capable of entering into a chemical reaction with an epoxy resin, as well as includes

iv) 0.05 to 2 pbw, if necessary, of further conventional additive substances,

under conventional pressure,

cross-linking of the mixture (4) with the mold, if necessary, being heated and

releasing of the structural part (5).

The invention relates to a method for the production of a fiber-reinforced product based on epoxy resin.

Such methods are known from prior art under the term resin transfer molding (RTM). Using this method, a fiber-reinforced product is produced by at least the following steps:

preforming of the fibrous material, if necessary,

placing of the fibrous material into a mold coated, if necessary, with parting means and closing the mold, wherein the molding of the fibrous material takes place,

injecting of a resin mixture under conventional pressure,

cross-linking the mixture with the mold heated, if necessary, and

releasing of the structural part.

For this method only resin mixtures with corresponding properties can be employed, which, on the one hand, make possible carrying out the method at all (simple injectibility, viscosity) and, on the other hand, lead to products having the desired mechanical or chemical properties. Resin mixtures based on polyesters, vinyl esters and epoxides are commonly used. In comparison to polyesters and vinyl esters, epoxy resins have the special advantage that they have lower shrinkage values, which generally has a positive effect on the mechanical characteristic data of the end product.

If conventional resin mixtures based on epoxides are employed for the RTM method, they are indeed simple to inject, but they lend the end product in general insufficient impact strength and damage tolerance against the effects of impacts which however, is required for many applications.

To improve the impact strength of resins, it is inter alia known to mix into the resin mixtures powdered soft filler substances, such as rubber meal with a particle diameter of approximately 5·10⁻⁵ m to 1·10⁻³ m. Such measures, however, still do not sufficiently improve the impact strength. In addition, the use of solid particles in resin transfer molding leads to the fact that the solid particles cannot penetrate the fibrous material. Consequently, the fibrous material cannot be coated with a homogeneous resin mixture, which has a negative effect on the properties of the end product.

The present invention addresses the problem of providing a product produced by the RTM method, which has excellent impact strength without having any effect on further mechanical or thermal characteristics.

The invention solves this problem through a method for the production of a fiber-reinforced product based on epoxy resin comprising the following steps:

if necessary, preforming the fibrous material,

placing the fibrous material into a mold coated, if necessary, with parting means and closing the mold, wherein the forming of the fibrous material takes place,

injecting a mixture which, relative to 100 pbw of the following components of the mixture, comprises

i) 50 to 70 pbw of an epoxy resin,

ii) 25 to 50 pbw of an aromatic diamine, and

iii) 2 to 25 pbw of cross-linkable elastomer particles based on polyorganosiloxanes with an average molecular weight of 1,000 to 100,000, with essentially only the surface of the elastomer particles having been modified with reactive groups, which are capable of entering into a chemical reaction with an epoxy resin, as well as includes

iv) 0.05 to 2 pbw, if necessary, of further conventional additives under conventional pressure,

cross-linking the mixture with, if necessary, the mold being heated, and

releasing the structural part.

By adding elastomer particles with the corresponding size, molecular weight and the modified surface, in general a considerable increase of the viscosity of the resin is expected, which would lead to the conclusion regarding considerable processing problems during the RTM. But surprisingly, this disadvantageous phenomenon did not occur.

Moreover, the disadvantage described in the introduction and anticipated with respect to the penetratability of the elastomer particles through the fibrous material, could also not be observed, so that a fine and homogeneous distribution of the elastomer particles in the structural part can be ensured.

The released product, furthermore, has increased impact strength compared to conventional resins based on epoxy resin for the RTM method. In comparison to the mixture not modified with the corresponding elastomer particles, the water uptake of the end products (with water storage) could be markedly decreased, which indicates improved resistance to hydrolysis. In connection with the high glass transition temperature (>200° C.) attainable through epoxy resins, products produced through resin transfer molding can now be produced without complications even oriented toward the most demanding application fields (for example aeronautics).

The epoxy resins employed are preferably diglycidyl ethers of bisphenols, in particular of bisphenol A and F as well as advancement resins produced therefrom, epoxidized novolaks, epoxidized fluorenone bisphenols, epoxidized o- or p-amino phenols as well as epoxidized polyaddition products of dicyclopentadiene and phenol. As a rule, they have an epoxide equivalent weight of 170 to 450 g. The proportion of weight of epoxy resin relative to all components of the mixture is 50-70 pbw, preferably 60-70 pbw. Multifunctional epoxy resins are especially suitable due to their functionality and the adaptation capabilities resulting therefrom to other components of the mixture or also to the fibrous material. Especially preferred have been found to be tetrafunctional epoxy resins, due to their very good mechanical properties as well as their high dimensional stability under heat. Especially preferred among them is tetraglycidyldiaminodiphenylmethane, since the end products produced therefrom have excellent resistance against water at increased temperatures and also against chemicals. These properties, combined with the high glass transition temperature (>200° C.), make possible the application of the end products in aeronautical and astronautical engineering.

A further component required for the resin mixture is an aromatic diamine as a curing agent component in stoichiometric ratios to the resin. 80 to 100% of the stoichiometric quantity of the aromatic diamine are necessary relative to an epoxide group. This means that in the mixture 25 to 50 pbw, preferably 25 to 35 pbw, relative to all components of the mixture of a diamine are comprised. An example is diaminodiphenylsulfone and the 4,4′-diaminodiphenylmethane. It is, moreover, of advantage if the aromatic diamine has in at least one ortho position to at least one amino group an alkyl group, in particular a methyl, ethyl or isopropyl group. Therewith the carcinogenic effect of the aromatic diamine is substantially eliminated. An example of this is 4,4′-methylene-bis(2,6diisopropyl) aniline. The use of diaminodiphenylmethane has the advantage that it can be mixed into the remaining components (in particular into the epoxy resin) without this mixture already reacting at ambient temperature. Consequently, for RTM a single-component system is provided which is stable in storage at ambient temperatures, which entails advantages in storage, during transport and in on-site application. Furthermore, the use of diaminodiphenylmethane has the advantage that it lends good working properties to the resin mixture over several hours at increased temperatures.

A further component of the resin mixture of the method according to the invention are three-dimensionally cross-linked elastomer particles based on polyorganosiloxanes, such as have been described in DE-OS 36 34 084 in concentrations of 2-25 pbw, preferably 2-5 pbw, relative to the weight of the total mixture. The quantity of the elastomer particles utilized depends on the desired properties of the end product and can be varied accordingly.

The average particle diameter of the elastomer particles is 1·10⁻⁸ m to 5·10⁻⁶ m, preferably 0.1 to 3 μm. The average molecular weight is 1,000 to 100,000, preferably 1,200 to 30,000. The surface of the elastomer particles has substantially been modified with reactive groups which are capable of entering into a chemical reaction with an epoxy resin.

Such polyorganosiloxanes can, for example, be used which can preferably be combined under the formula —(R₂SiO)—, where R can be the radicals described in DE-OS 36 34 084. Mixtures of different polyorganosiloxanes are also possible. For example, preferably polyorganosiloxanes can be used having the general formula (—R′₂SiO)ₓ—(R″₂SiO)_{y}— with the radicals disclosed in DE-OS 36 34 084. Generally preferred are polyorganosiloxanes, in which at least 50% of the radicals R, R′, R″ represent methyl and/or phenyl groups. The surface of the polyorganosiloxanes have reactive groups, which are capable of forming a chemical bond with the epoxy resin. The reactive groups on the surface of the polyorganosiloxane are, for example, preferably an epoxide group but also an amino, carboxy and/or carboxylic acid anhydride group. The manner by which this surface modification can be generated is also found in DE-OS 36 34 084.

If necessary, further conventional components can be, for example, reaction mediators, dispersing agents, cross-linkage mediators but also processing aids such as, for example, deaerators. The additives are added in concentrations of 0.05 to 2 pbw, preferably 0.07 to 1 pbw, relative to 100 pbw of the total mixture.

The preparation of the resin mixtures is extremely simple. A dispersion of 25 to 50 pbw (relative to 100 pdw of the total mixture) of one or several three-dimensionally cross-linkable polyorganosiloxanes is mixed with, if necessary, auxiliary agents such as cross-linkage means, dispersing agents, catalysts as well as the epoxy resin and the diamine and, if necessary, further conventional additives. This resin mixture is stable during storage at ambient temperature. Further advantageous implementations for the production of the resin mixture can be found in DE-OS 36 34 084.

In RTM the substantially dry fibrous material (for example glass, carbon or aramide fibers) in the form of woven fabric, plaiting, nonwoven fabric, randomly oriented fiber matting or fibrous webs are placed into the mold. Preferred is the use of carbon and glass fibers.

The fibrous material is preformed, which, in the simplest case, corresponds to a rough-pressing of the fibrous material provided with a binding agent, in order to maintain it in a form stable during storage. Before the fibrous material is placed into the mold, the mold is provided with antiadhesion means (parting means). This can be a solid Teflon layer or also a means applied correspondingly before each fabrication of a structural part. The mold is closed and the low-viscosity resin mixture is injected into the mold under conventional pressure (<6 bar). The injection is terminated when the level of resin fill in the mold can be detected using a riser. The curing of the resin subsequently takes place and the cross-linking of the polyorganosiloxane particles in the mold, which, as a rule, is promoted by heating it. Simultaneously the bonding of the polyorganosiloxane particles to the epoxy resin matrix occurs through the reaction of the reactive groups of the polyorganosiloxane with the epoxy resin. This does not decrease the cross-link concentration of the cured resin.

When the curing or cross-linking is concluded, the structural part can be removed, for example with the support of ejection systems.

As already stated, the products manufactured according to the invention can be applied in the field of astronautical and aeronautical engineering. Another application field would be, for example, automobile construction.

The invention will be explained in further detail in conjunction with an embodiment example.

The sole FIGURE shows schematically the sequence in resin transfer molding (RTM) in steps (1) to (5).

In a (not shown) process step fibrous material 2 (3 mm thick carbon fiber matting of 8 layers of carbon fibers—Kramer 445 T, fiber volume fraction 52%) is preformed in a mold by closing the mold. This process step, if necessary, can be omitted. This preformed fiber piece 2 is next placed into a mold 1, depicted in process step (1), with the latter having been coated with parting means. The mold 1 is closed (process step (2)). Through a corresponding injection device 3 the resin mixture 4 is introduced into the mold 1 under a pressure of 4 bar as evident in process step (3). It is possible to mix the resin components directly in an integrated mixer in the injection device. The resin mixture employed for the method according to the invention, has the advantage that it is stable during storage at ambient temperature, such that a single-component system can be utilized without encountering complications.

TABLE 1
Resin mixture composition

| | Composition | Composition |
|---|---|---|
| | [percent | [percent by weight] |
| | by weight] | according to the |
| Component | prior art | invention |
| Epoxy resin | 69.4 | 63.6 |
| tetraglycidyldiaminodiphenylmethane | | |
| Diamine | 30.6 | 29.2 |
| 4,4′-diaminodiphenylmethane | | |
| Polyorganosiloxane | — | 7.0 |
| A 530 ** | — | 0.2 |

** Byk GmbH, Germany

Experiments on the cured (heated at 2° C./min to 180° C., 60 min at 180° C.) Resin mixture (composition Table 1) compiled in Table 2:

TABLE 2

| | | Composition |
|---|---|---|
| | | according to |
| Properties | Prior Art | the invention |
| Glass temperature [° C.] | 217 | 217 |
| Glass temperature [° C.] | 215 | 205 |
| measured after storage (14 days | | |
| at 70° C.) in distilled water | | |
| Bending strength | 3100 | 3200 |
| DIN 53452 ISO 178 [MPa] | | |
| Water uptake [%] | 2.5 | 1.7 |
| measured after storage (14 days | | |
| at 70° C.) in distilled water | | |
| Crack growth energy [J/m²] | 160 | 250 |

Table 2 clearly shows that the water uptake (14 days at 70° C. in distilled water) of the resin mixture of prior art is higher than that of the resin mixture according to the invention. The decreased capability of taking up water of the mixture according to the invention indicates improved resistance to hydrolysis of the end product. Furthermore, Table 2 shows that the bending strength and the crack growth energy of the resin according to the invention could be increased in comparison to prior art, which is evidence of improved breaking behavior of the cured mixture.

The resin mixtures listed in Table 1 were injected into the mold 1 of the sole FIGURE and cured at a heating rate of 2° C./min from 30° C. to 180° C. (process step (4)). During the heating no viscosity difference between the resin mixture of prior art and the resin mixture according to the invention could be detected. The final through-curing of the resin was completed at 180° C. over 2 hours. After a brief cooling phase, the structural part was removed (process step (5)). The fiber-reinforced product has the following characteristics:

TABLE 3

| | | Composition |
|---|---|---|
| | | according to |
| Properties | Prior Art | the invention |
| Glass temperature [° C.] | 216 | 205 |
| Bending strength | | |
| DIN 53452 ISO 178 [MPa] | | |
| Ambient temperature | 693 | 881 |
| 120° C. | 611 | 656 |
| Brief bending strength | | |
| DAN 432 [MPa] | | |
| −55° C. | 69 | 76 |
| Ambient temperature | 58 | 61 |
| 120° C. | 38 | 44 |

The values of the bending strength show that structural parts manufactured in resin transfer molding according to the invention are able to withstand higher mechanical loading than previously produced structural parts.

1. Method for the production of a fiber-reinforced product based on epoxy resin comprising the following steps:
if necessary, preforming of the fibrous material (2),
placing the fibrous material (2) into a mold (1), if necessary, coated with parting means, and closing of the mold (1), wherein the molding of the. fibrous material (2) takes place,
injecting a mixture (4) which, relative to 100 pbw of the following components of the mixture, comprises
i) 50 to 70 pbw of an epoxy resin,
ii) 25 to 50 pbw of an aromatic diamine, and
iii) 2 to 25 pbw of cross-linkable elastomer particles based on polyorganosiloxanes with an average particle diameter of 1·10⁻⁸ m to 5 10−6 m and an average molecular weight of 1,000 to 100,000, with substantially only the surface of the elastomer particles having been modified with reactive groups, which are capable of entering into a chemical reaction with an epoxy resin, as well as include
iv) 0.05 to 2 pbw, if necessary, of further conventional additive substances,
under conventional pressure,
cross-linking of the mixture (4) with the mold, if necessary, being heated and
releasing of the structural part (5).

2. Method for the production of a fiber-reinforced product based on epoxy resin as claimed in claim 1 comprising the following steps:
if necessary, preforming of the fibrous material (2),
placing the fibrous material (2) into a mold (1), if necessary, coated with parting means, and closing of the mold (1), wherein the molding of the fibrous material (2) takes place,
injecting a mixture (4) which, relative to 100 pbw of the following components of the mixture, comprises
i) 60 to 70 pbw of an epoxy resin,
ii) 25 to 35 pbw of an aromatic diamine, and
iii) 2 to 5 pbw of cross-linkable elastomer particles based on polyorganosiloxanes with an average particle diameter of 1·10⁻⁸ m to 5·10⁻⁶ m and an average molecular weight of 1,000 to 100,000, with substantially only the surface of the elastomer particles having been modified with reactive groups, which are capable of entering into a chemical reaction with an epoxy resin, as well as includes
iv) 0.07 to 1 pbw, if necessary, of further conventional additive substances,
under conventional pressure,
cross-linking of the mixture (4) with the mold, if necessary, being heated and
releasing of the structural part (5).

3. Method as claimed in at least one of the preceding claims, characterized in that a multifunctional epoxy resin is utilized.

4. Method as claimed in claim 3, characterized in that a tetrafunctional epoxy resin is utilized.

5. Method as claimed in claim 4, characterized in that the tetrafunctional resin utilized is tetraglycidyldiarninophenylmethane.

6. Method as claimed in at least one of the preceding claims, characterized in that diaminodiphenylmethane is utilized as the aromatic diamine.

7. Method as claimed in at least one of the preceding claims, characterized in that the aromatic diamine has in at least one ortho position to at least one amino group an alkyl group, in particular a methyl, ethyl or isopropyl group.

8. Method as claimed in at least one of the preceding claims, characterized in that the modified elastomer particles have an average particle size of 1·10⁻⁷ m to 3·10⁻⁶ m.

9. Method as claimed in at least one of the preceding claims, characterized in that the elastomer particles have an average molecular weight of 1,200 to 30,000.

10. Use of the product manufactured according to the method as claimed in at least claim 1 in aeronautical and astronautical engineering.
